(19) United States
(12) Patent Application Publication
(10) Pub. No.: US 2014/0017365 A1
(43) Pub. Date: Jan. 16, 2014

(54) METHODS AND SYSTEMS FOR STABILIZATION OF A FLUID USING APPLIED ELECTRICAL FIELDS

(71) Applicants: Robert Warren Taylor, Ponte Vedra Beach, FL (US); Bradley Stephen Rogers, Leawood, KS (US); James Easel Roberts, Simpsonville, SC (US); Allen Lawrence Garner, Clifton Park, NY (US)

(72) Inventors: Robert Warren Taylor, Ponte Vedra Beach, FL (US); Bradley Stephen Rogers, Leawood, KS (US); James Easel Roberts, Simpsonville, SC (US); Allen Lawrence Garner, Clifton Park, NY (US)

(21) Appl. No.: 13/548,710

(22) Filed: Jul. 13, 2012

(51) Int. Cl. C12H 1/02; C25B 7/00; B03C 5/00

(52) U.S. Cl. 426/239; 204/627

(57) ABSTRACT

Methods and systems for fluid stabilization are provided. The system includes a first electrical field generator positioned adjacent to a first passage. The first electrical field generator imparts a first electrical field to a fluid flowing through the first passage such that first particles and second particles entrained in the fluid are charged to a first polarity. A first collector positioned within the first passage collects the first particles charged in the fluid. A second electrical field generator positioned adjacent to a second passage is downstream from the first electrical field generator. The second electrical field generator imparts a second electrical field to the fluid discharged from the first passage and substantially neutralizes the second particles entrained in the fluid.

### BACKGROUND OF THE INVENTION

The embodiments described herein relate generally to fluid stabilization, and more specifically to stabilization of fluids using applied electrical fields.

At least some known processes used in stabilizing consumable fluids require removal of certain undesired particles. For example, at least some particles introduced into a consumable fluid during processing may reduce the shelf life and/or alter the flavor, appearance, and/or smell of the fluid. In contrast, at least some particles are desired in the fluid as they may enhance the flavor, appearance, smell, and/or other characteristics of the fluid. However, using known filtering systems, it may be difficult to remove certain particles from consumable fluids without altering or inadvertently removing other particles.

Known filtration methods for use with consumable fluids use surface filtration, cake filtration, holding and/or settling tanks, and/or centrifugation. Moreover, known particle removal systems may be time-consuming, costly, inefficient, and/or wasteful.

In addition, after filtering, at least some consumable fluids require a pasteurization process to neutralize harmful pathogens. The pasteurization process often involves heating the fluid to a high temperature for an elapsed time period, followed by cooling the fluid. Because known pasteurization processes subject all particles to heating, in some instances, the desired particles may be undesirably altered or neutralized through exposure to the heat. For example, known processes of brewing beer include a fermentation step that introduces yeast, bacteria, and protein into the beer. The yeast and bacteria may be removed in filtration and pasteurization processes, respectively. Protein in beer helps to define the beer's foam or “head”, which is important to the beer's appearance, flavor, and aroma. Therefore, it is desirable to remove yeast and bacteria from beer without altering the protein content. However, removing the yeast by waiting for it to settle is generally inefficient and time consuming, while centrifugation may require costly equipment and usually wastes some beer. After filtration, at least some beer is pasteurized to neutralize bacteria. However, the heating associated with pasteurization can also neutralize proteins, and potentially reduce the quality of the beer.

### BRIEF DESCRIPTION OF THE INVENTION

In one aspect, a fluid stabilization system is provided. The system includes a first electrical field generator positioned adjacent to a first passage. The first electrical field generator imparts a first electrical field to a fluid flowing through the first passage such that first particles and second particles entrained in the fluid are charged to a first polarity. A first collector positioned within the first passage collects the first particles charged in the fluid. A second electrical field generator positioned adjacent to a second passage is downstream from the first electrical field generator. The second electrical field generator imparts a second electrical field to the fluid discharged from the first passage and substantially neutralizes the second particles entrained in the fluid.

In another aspect, a method of stabilizing fluid is provided. The method includes imparting a first electrical field to a fluid flowing through a first passage such that first particles and second particles entrained in the fluid are charged to a first polarity, collecting the first particles charged in the first passage, directing the fluid to a second passage downstream from the first passage, and imparting a second electrical field to the fluid flowing through the second passage to facilitate substantially neutralizing the second particles entrained in the fluid.

In yet another aspect, a beer brewing system is provided. The system includes a first electrical field generator positioned adjacent to a first passage. The first electrical field generator imparts a first electrical field to beer flowing through the first passage such that a plurality of particles entrained in the beer including yeast, bacteria, and protein particles are charged to a first polarity. A first collector positioned within the first passage collects the yeast particles charged in the beer. A second electrical field generator positioned adjacent to a second passage downstream from the first electrical field generator imparts a second electrical field to the beer discharged from the first passage and substantially neutralizes the bacteria particles entrained in the beer.

### BRIEF DESCRIPTION OF THE DRAWINGS

FIG. 1 is a functional block diagram of an exemplary fluid stabilization system.

FIG. 2 is a perspective schematic view of a portion of an electrical field generator that may be used with the fluid stabilization system shown in FIG. 1.

FIG. 3 is a cross-sectional view of an alternative electrical field generator that may be used with the fluid stabilization system shown in FIG. 1.

FIG. 4 is a flow chart of an exemplary method that may be used to stabilize fluids.

### DETAILED DESCRIPTION OF THE INVENTION

The exemplary systems and methods described herein overcome at least some disadvantages of known fluid stabilization methods by providing a stabilization system that enables discriminate filtration and neutralization of specified undesirable particles entrained in fluid, without damaging other specified desirable particles in the fluid. The system facilitates the filtration of specified undesirable particles in a time-efficient manner without wasting excess fluid. Moreover, the system facilitates the neutralization of other specified undesirable particles without damaging desirable particles and reducing the quality of the fluid.

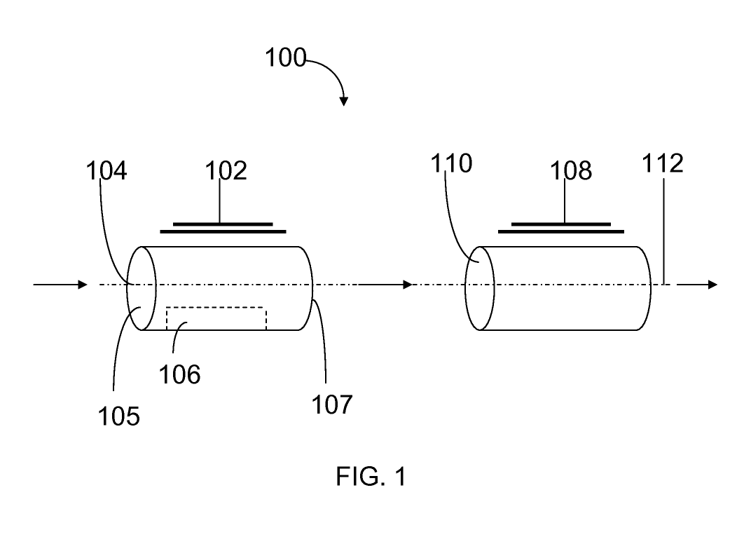

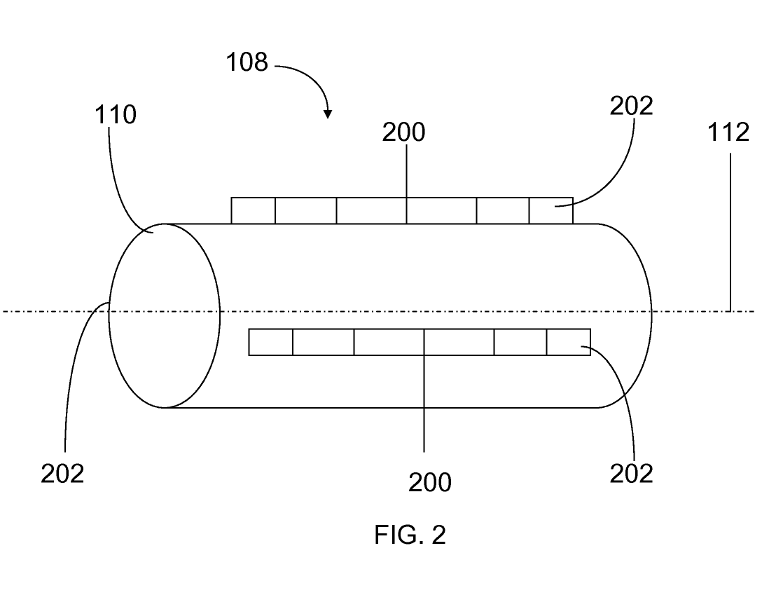

FIG. 1 is a block diagram of an exemplary fluid stabilization system 100. FIG. 2 is a perspective schematic view of a portion of an electrical field generator 108 that may be used with fluid stabilization system 100. In the exemplary embodiment, fluid stabilization system 100 includes a first electrical field generator 102, a first passage 104, a first collector 106, a second electrical field generator 108, and a second passage 110, that are coupled together in serial flow-communication. First passage 104 is positioned to receive a particle-laden fluid. In some embodiments, the fluid is discharged from a fermentation tank (not shown) into first passage 104. More specifically, in the exemplary embodiment, the fluid is a beer that contains particles entrained therein. For example, the beer may include yeast particles, bacteria particles, and protein particles entrained therein. First electrical field generator 102 is positioned adjacent to first passage 104 and can selectively apply an electrical field to first passage 104. More specifically, during use, first electrical field generator 102 induces an electric field to fluid flowing through first passage 104. In the exemplary embodiment, first electrical field generator 102 is positioned to induce an electric field substantially circumferentially into fluid flowing through first passage 104.

First passage 104 includes an inlet 105 that enables fluid to enter passage 104, and an outlet 107 that enables fluid to exit passage 104. In the exemplary embodiment, first electrical field generator 102 is positioned to induce an electric field substantially circumferentially into fluid flowing through first passage 104. In the exemplary embodiment, first passage 104 is cylindrical. First passage 104 has a central axis that extends radially therethrough. In an alternative embodiment, first passage 104 includes a plurality of parallel passages (not shown) aligned in a predetermined array. In such an embodiment, the fluid is generally divided equally among the plurality of passages, where each passage is exposed to an electrical field.

First electrical field generator 102 is positioned adjacent to first passage 104, such that first electrical field generator 102 can selectively apply a first electrical field to first passage 104. More specifically, in the exemplary embodiment, first electrical field generator 102 selectively charges the fluid, and the particles entrained therein to a first polarity. More specifically, in the exemplary embodiment, activation of first electrical field generator 102 negatively charges yeast particles, bacteria, and protein entrained in the fluid. The strength and/or frequency of first electrical field are each selectively adjustable relative to first passage 104. Particles having a larger mass tend to hold a greater charge than smaller particles, and as such, are charged to the first polarity for removal. In an alternative embodiment, first electrical generator 102 may be coupled to first passage 104.

First collector 106 is positioned within first passage 104 for use in separating and collecting specific particles. First collector 106 also includes a collection plate (not shown) that functions as an electrical ground for first electrical field generator 102. More specifically, as charged particles flow through first passage 104, first collector 106 attracts the desired first particles based on the electrical field strength and/or frequency of the charge applied to first passage 104. Any remaining, and untargeted, particles do not carry a sufficient charge to be attracted to first collector 106 and, as such, are discharged from first passage 104 and towards second passage 110. For example, in the exemplary embodiment, yeast particles are generally larger than other entrained particles and are charged to a negative polarity by first electrical field generator 102 prior to being collected by first collector 106, and the smaller sized bacteria and protein particles do not receive a sufficient charge from generator 102 and are discharged through outlet 107 towards second passage 110.

Second passage 110 is downstream from first passage 104 and receives fluid discharged from first passage 104. More specifically, in the exemplary embodiment, fluid entering second passage 110 may include bacteria particles and protein particles entrained therein. Second electrical field generator 108 is positioned adjacent to second passage 110, such that second electrical field generator 108 can selectively induce a second electrical field to second passage 110. More specifically, during use, second electrical field generator 108 induces an electric field to fluid flowing through second passage 110, and more specifically, in the exemplary embodiment, generator 108 induces an electric field substantially circumferentially into fluid flowing through second passage 110. In the exemplary embodiment, second passage 110 is cylindrical and includes a central axis 112 extending therethrough. In an alternative embodiment and as shown in FIG. 2, second passage 110 includes a plurality of parallel passages aligned in a predetermined array. In such an embodiment, the fluid is generally divided equally among the plurality of passages, where each passage is exposed to an electrical field.

Second electrical field generator 108 is positioned adjacent to second passage 110, such that second electrical field generator 108 can selectively apply a second electrical field to second passage 110. Second electrical field generator 108 is configured to charge the fluid to a second polarity. More specifically, in the exemplary embodiment, second electrical field generator 108 pulses the second electrical field to facilitate neutralizing bacteria particles entrained in the fluid. To facilitate exposing the bacteria particles to the second electrical field, a uniform electrical field is created by inducing rotation of the fluid in second passage 110, as is further described below. The strength and/or frequency of second electrical field are each adjustable relative to second passage 110 to target desired second particles. In an alternative embodiment, second electrical field generator 108 may be coupled to second passage 110.

In the exemplary embodiment, second electrical field generator 108 induces rotation of the second particles entrained in the fluid to create an electrostatic field within second passage 110. The rotation, and electrostatic field, may be created using multiple electrodes 202 that are circumferentially spaced in groups about passage 110. The electrodes are powered by a power supply, for example, a multi-phase power supply, that when activated, facilitates creating the rotating electric field within passage 110. More specifically, in the exemplary embodiment, second electrical field generator 108 includes three groups 200 of electrodes 202 spaced circumferentially about second passage 110, and each group 200 of electrodes 202 is oriented to extend substantially parallel to central axis 112 of second passage 110. In the exemplary embodiment, the groups 200 of electrodes 202 are substantially equally spaced circumferentially about second passage 110 such that the phase of the voltage waveforms supplied to each group 200 of electrodes 202 is approximately 120 degrees. The frequency is substantially constant between each electrode 202, such that the desired rotation of the charged second particles flowing through second passage 110 is created. In other embodiments, any number of electrodes 202 may used with second electrical field generator 108 that enables fluid stabilization system 100 to function as described herein.

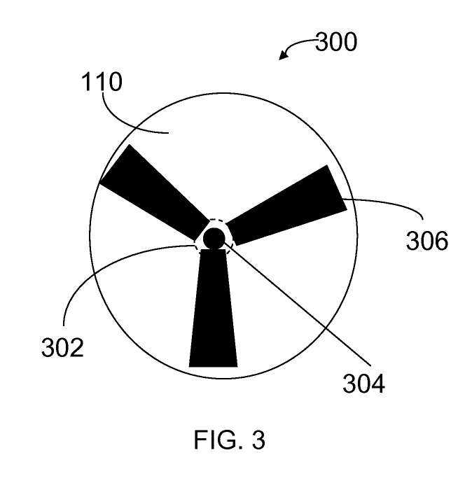

FIG. 3 is a cross-sectional view of an alternative second electrical field generator 300 that may be used with fluid stabilization system 100 (shown in FIG. 1). In the exemplary embodiment, one or more impellers 302 are positioned within second passage 110 for inducing rotation of the fluid flowing therethrough. Impeller 302 includes at least one turning vane 306 and at least one electrode 304 embedded within impeller 302. Second electrical field generator 300 is electrically coupled to electrode 304 and is configured to pulse voltage through electrode 304 to impart the second electrical field to the fluid.

In an alternative embodiment, a second collector (not shown) may be positioned within second passage 110 for attracting particles after their neutralization. Second collector may include a collection surface that is charged at a second polarity opposite the first polarity. As the second particles are charged and rotate around second passage 110, second collector discriminately attracts the second particles based on the electrical field strength and/or frequency. Other particles within the fluid that are not targeted do not carry a large enough charge to be attracted to second collector and flow out of second passage 110 with the fluid. Second collector may be removed when the flow of fluid is stopped to facilitate removal of the neutralized second particles or, alternatively, the second electrical field may be stopped to allow the neutralized second particles to be absorbed back into the fluid.

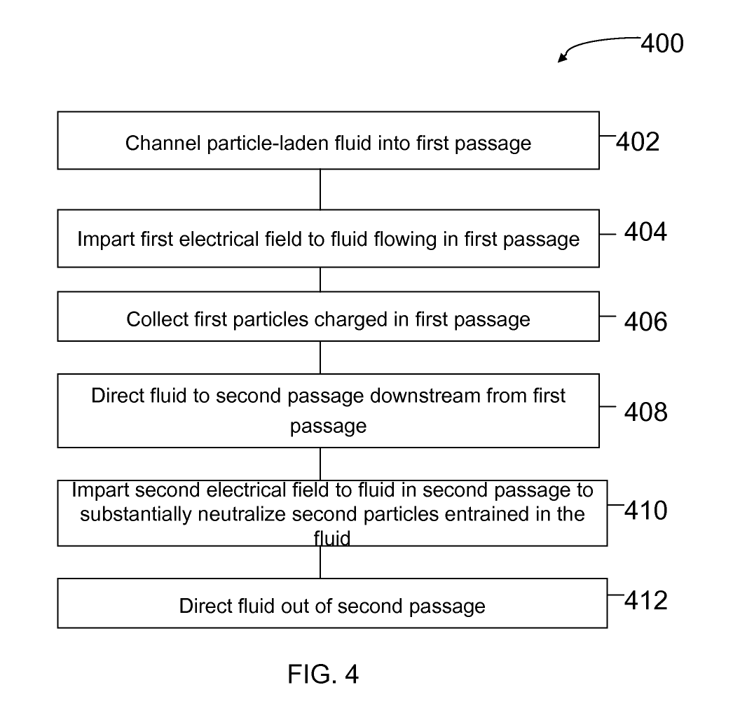

FIG. 4 is a flow chart of an exemplary method that may be implemented to stabilize fluid using a fluid stabilization system 100 (shown in FIG. 1). During operation, a particle-laden fluid is initially channeled 402 into a first passage 104 (shown in FIG. 1). A first electrical field generator 102 (shown in FIG. 1) imparts 404 a first electrical field on the fluid to induce a charge on all particles entrained in the fluid. Specifically, first electrical field generator 102 charges the entrained particles to a first polarity. Based on the strength and/or frequency of the first electrical field, at least some particles are removed from the fluid. Specifically, a first collector 106 (shown in FIG. 1) collects 406 at least some particles and the fluid is then channeled 408 downstream to a second passage 110 (shown in FIG. 1). A second electrical field generator 108 (shown in FIG. 1) imparts 410 second electrical field at the same polarity on the fluid with at least one electrode 202. The magnitude of second electrical field is selected to cause the cell membranes of the second particles to break down and become more permeable. Moreover, as the permeability of the particles is increased, the particles are subject to absorption by surrounding fluids, a process known as electroporation. The second particles are then either released into the fluid for absorption or are collected on second collector (not shown) until the fluid is cleaned. The fluid then primarily contains desirable particles, wherein the first particles have been removed, and the second particles have been neutralized. The cleaned fluid is then directed 412 from second passage 110.

The above-described systems and methods provide a fluid stabilization system that enables the filtration of certain specified particles and neutralization of other specified particles entrained in the fluid without damaging certain desirable particles in the fluid. The filtration process is time and energy efficient and does not create wasted fluid. Specifically, when used in a beer brewing process, yeast particles can be filtered from beer without wasting excess product. The neutralization process enables the efficient neutralization of certain particles without heating the fluid, which may damage desired particles. Specifically, the neutralization process can be used to neutralize bacteria in beer without damaging protein particles that contribute to the flavor of the beer. The system provides fluid stabilization in a cost-effective, time-efficient, and reliable manner.

Exemplary embodiments of systems and methods for the stabilization of fluids containing objectionable particles using applied electrical fields are described above in detail. The systems and method are not limited to the specific embodiments described herein, but rather, components of systems and/or steps of the methods may be utilized independently and separately from other components and/or steps described herein. For example, the methods may also be used in combination with other fluid stabilization systems and methods, and are not limited to practice with only the consumable fluid stabilization systems and methods as described herein. Rather, the exemplary embodiment can be implemented and utilized in connection with many other stabilization applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A fluid stabilization system comprising:
a first electrical field generator positioned adjacent to a first passage, said first electrical field generator configured to impart a first electrical field to a fluid flowing through said first passage such that a plurality of first particles and a plurality of second particles entrained in the fluid are charged to a first polarity;
a first collector positioned within said first passage, said first collector configured to collect first particles charged in the fluid; and
a second electrical field generator positioned adjacent to a second passage, said second electrical field generator downstream from said first electrical field generator and configured to:
impart a second electrical field to the fluid discharged from said first passage; and
substantially neutralize the plurality of second particles entrained in the fluid.

2. The fluid stabilization system of claim 1, further comprising a second collector coupled to said second passage, said second collector configured to collect second particles charged in the fluid.

3. The fluid stabilization system of claim 1, wherein said first collector is configured to collect yeast particles entrained in the fluid.

4. The fluid stabilization system of claim 1, wherein said second electrical field generator is configured to substantially neutralize bacteria particles entrained in the fluid.

5. The fluid stabilization system of claim 1, wherein said second electrical field generator is configured to substantially neutralize the plurality of second particles entrained in the fluid via electroporation.

6. The fluid stabilization system of claim 1, wherein said second electrical field generator is configured to induce rotation of the plurality of second particles entrained in the fluid within said second passage.

7. The fluid stabilization system of claim 1, wherein said second passage further comprises at least one impeller configured to induce rotation of the plurality of second particles entrained in the fluid within said second fluid passage.

8. The fluid stabilization system of claim 1, wherein said second passage comprises a plurality of substantially parallel second passages aligned in a predetermined array, said second electrical field generator creates an electrical field within the fluid.

9. A method of stabilizing fluid, said method comprising:
imparting a first electrical field to a fluid flowing through a first passage such that a plurality of first particles and a plurality of second particles entrained in the fluid are charged to a first polarity;
collecting first particles charged in the first passage;
directing the fluid to a second passage downstream from the first passage; and
imparting a second electrical field to the fluid flowing through the second passage to facilitate substantially neutralizing the plurality of second particles entrained in the fluid.

10. The method of stabilizing fluid of claim 9, wherein collecting first particles charged in the first passage comprises collecting charged yeast particles entrained in the fluid.

11. The method of stabilizing fluid of claim 9, wherein imparting a second electrical field to the fluid comprises:
pulsing the second electrical field; and
inducing rotation of the plurality of second particles within the second passage.

12. The method of stabilizing fluid of claim 9, wherein substantially neutralizing the plurality of second particles further comprises collecting the second particles entrained in the fluid.

13. The method of stabilizing fluid of claim 9, wherein substantially neutralizing the plurality of second particles comprises substantially neutralizing the plurality of second particles via electroporation.

14. The method of stabilizing fluid of claim 9, wherein substantially neutralizing the second particles comprises substantially neutralizing bacteria particles entrained in the fluid.

15. A beer brewing system comprising:
a first electrical field generator positioned adjacent to a first passage, said first electrical field generator configured to impart a first electrical field to beer flowing through said first passage such that a plurality of particles entrained in the beer including yeast, bacteria, and protein particles are charged to a first polarity;
a first collector positioned within said first passage, said first collector configured to collect yeast particles charged in the beer;
a second electrical field generator positioned adjacent to a second passage downstream from said first electrical field generator and configured to:
impart a second electrical field to the beer discharged from said first passage; and
substantially neutralize the bacteria particles entrained in the beer.

16. The beer brewing system of claim 15, further comprising a second collector positioned within said second passage, said second collector configured to collect the bacteria particles entrained in the beer.

17. The beer brewing system of claim 15, wherein said second electrical field generator is configured to substantially neutralize the bacteria particles entrained in the fluid via electroporation.

18. The beer brewing system of claim 15, wherein said second electrical field generator is configured to induce rotation of the bacteria particles within said second passage.

19. The beer brewing system of claim 15, wherein said second passage further comprises at least one impeller configured to induce rotation of the bacteria particles within said second passage.

20. The beer brewing system of claim 15, wherein said second passage comprises a plurality of substantially parallel second passages aligned in a predetermined array, said second electrical generator creates an electrical field within the fluid.
